(19) United States
(12) Patent Application Publication
(10) Pub. No.: US 2024/0070930 A1
(43) Pub. Date: Feb. 29, 2024

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventors: Chiemi MIYATA, Kanagawa (JP); Koichi SATO, Kanagawa (JP); Toru TAKAHASHI, Kanagawa (JP)

(73) Assignee: FUJIFILM Business Innovation Corp., Tokyo (JP)

(21) Appl. No.: 18/180,239

(22) Filed: Mar. 8, 2023

(30) Foreign Application Priority Data
Aug. 30, 2022 (JP) 2022-136831

(51) Int. Cl. G06T 11/00; H04N 1/00

(52) U.S. Cl. CPC G06T 11/00; H04N 1/00286; H04N 1/0044

(57) ABSTRACT

An information processing apparatus includes a processor configured to: acquire a video captured by photographing a side of a document where an entry is filled; and output an unfilled entry of the document in the video.

### CROSS-REFERENCE TO RELATED APPLICATIONS

This application is based on and claims priority under 35 USC 119 from Japanese Patent Application No. 2022-136831 filed Aug. 30, 2022.

### BACKGROUND

### (i) Technical Field

The present disclosure relates to an information processing apparatus, a non-transitory computer readable medium, and an information processing method.

### (ii) Related Art

User assistance techniques are available in the use of image processing apparatuses.

Japanese Unexamined Patent Application Publication No. 2017-033454 discloses an information input apparatus. The information input apparatus includes a registration unit that registers form information. The form information associates a feature value of a business form having multiple entry fields with a type of an object to be used by a user in each entry field. The information input apparatus further includes a projection unit that projects a specific image, a reading unit that reads a placed business form, and an acquisition unit that acquires a distance image responsive to an operation of the user. The information input apparatus further includes a first recognition unit that recognizes a business form obtained by checking a feature value, extracted through analysis of an image read from the business form, with a registered feature value of the business form and also recognizes multiple entry fields printed on the business form. The information input apparatus further includes a second recognition unit that recognizes an object that is operated by a user who analyzes the distance image from the acquisition unit and also recognizes the type of the object. The information input apparatus further includes a control unit that, in response to a change of the type of the object that is operated by the user and is by the second recognition unit, controls the projection unit such that the specific image is projected to an entry field of the business form associated with the type of the object to be used by the user, from among the entry fields recognized by the first recognition unit.

Japanese Unexamined Patent Application Publication No. 2007-013972 discloses an image creation method. The image creation method monitors a movement in an imaged region and triggers capturing of an image in the region in response to monitoring results indicating a stop of the movement in the region.

Japanese Unexamined Patent Application Publication No. 2016-012751 discloses an image processing apparatus. The image processing apparatus includes a verification unit that verifies contents written in a specific entry field in a document read by an image reader, and a determination unit that determines in view of verification results whether to transmit the read document in accordance with the contents written in the entry field.

Users may fill in a variety of information in an entry of a document in various procedures to apply for the procedures.

Filling omission could occur possibly because of various circumstances or because of too many entries.

### SUMMARY

Aspects of non-limiting embodiments of the present disclosure relate to providing an information processing apparatus, a non-transitory computer readable medium, and an information processing method, assisting users to verify the presence or absence of filling omission.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire a video captured by photographing a side of a document where an entry is filled; and output an unfilled entry of the document in the video.

### BRIEF DESCRIPTION OF THE DRAWINGS

Exemplary embodiment of the present disclosure will be described in detail based on the following figure, wherein:

FIG. 1 is a perspective view illustrating an example of a general configuration of an image processing apparatus of an exemplary embodiment;

FIG. 2 is a block diagram illustrating a hardware configuration of the image processing apparatus of the exemplary embodiment;

FIG. 3 is a flowchart illustrating the flow of an assistance process of the image processing apparatus of the exemplary embodiment;

FIG. 4 illustrates an example of a document placed on a document holder and an identification notification of the document;

FIG. 5 illustrates an example of a document display region displayed on a display;

FIG. 6 illustrates an example of a display that receives a designation of an entry;

FIG. 7 illustrates an example of a document placed on the document holder;

FIG. 8 illustrates an example of the document display region displayed on the display;

FIG. 9 illustrates an example of the document placed on the document holder;

FIG. 10 illustrates an example of the display that performs scanning;

FIG. 11 illustrates an example of the document placed on the document holder; and

FIG. 12 illustrates an example of the display when a shield overlaps an unfilled entry.

### DETAILED DESCRIPTION

Exemplary embodiment of the disclosure is described below with reference to the drawings. In the drawings, like or equivalent elements are designated with like reference numerals. Dimension ratios in the drawings are exaggerated for convenience of explanation and are sometimes not to scale.

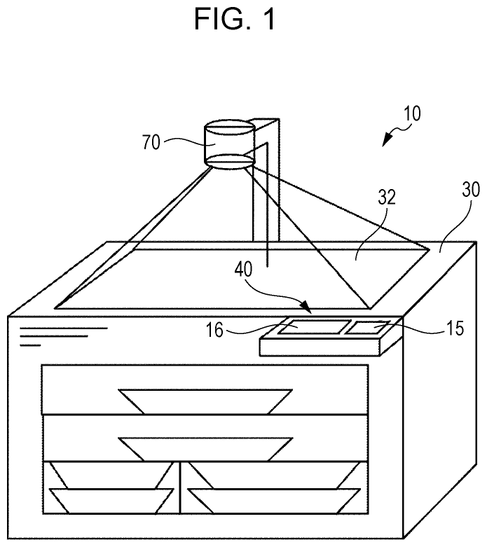

FIG. 1 is a perspective view illustrating the general configuration of an image processing apparatus 10 of the exemplary embodiment of the disclosure. An information processing apparatus of technique of the exemplary embodiment may be installed in a government office, office, school, or home and may be applied to the image processing apparatus 10 with a camera as described below.

The image processing apparatus 10 includes a document holder 30 with a file as a document placed on the top surface of the document holder 30, a user interface 40 that displays or enters a variety of information, and a document camera 70.

The document holder 30 serves as a workbench on which a user places a document and fills entries on a document.

The user interface 40 includes an input unit 15 receiving inputs, and a display 16 including a liquid-crystal display. The user interface 40 may include a touch panel and thus a unitary body including the input unit 15 and display 16. The image processing apparatus 10 displays on the display 16 a video photographed by the document camera 70.

The document camera 70 is configured to photograph the top surface of the document holder 30. For example, an arm is secured at one end to the rear side of the document holder 30, and the document camera 70 is mounted on the other end of the arm. The document camera 70 is positioned such that a view angle of photograph of the document camera 70 substantially covers a document placement region 32. A smart phone or a tablet terminal, including a camera, may be used in place of the document camera 70. In such a case, the image processing apparatus 10 receives a video from the smart phone or tablet terminal.

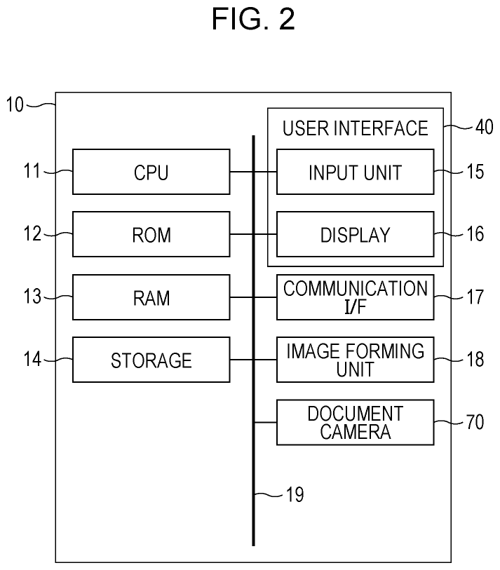

FIG. 2 is a block diagram illustrating a hardware configuration of the image processing apparatus 10. The image processing apparatus 10 includes a central processing unit (CPU) 11, read-only memory (ROM) 12, random-access memory (RAM) 13, storage 14, input unit 15, display 16, communication interface (I/F) 17, image forming unit 18, and document camera 70. These elements are communicably interconnected to each other via a bus 19.

The CPU 11 executes a variety of programs and controls elements in the image processing apparatus 10. Specifically, the CPU 11 reads a program from the ROM 12 or storage 14, and executes the program using the RAM 13 as a working area. In accordance with the program stored on the ROM 12 or storage 14, the CPU 11 controls the elements and performs a variety of arithmetic operations. According to the exemplary embodiment, the ROM 12 or storage 14 stores an information processing program that assists a user to verify the presence or absence of filling omission.

The ROM 12 stores a variety of programs and a variety of data. The RAM 13 temporarily stores the programs or data. The storage 14 includes a hard disk drive (HDD) or solid-state drive (SSD), and stores a variety of programs, including an operating system, and a variety of data.

The input unit 15 includes a pointing device, such as a mouse, and a keyboard and is used to enter a variety of inputs.

The display 16 is, for example, a liquid-crystal display and displays a variety of information.

The user interface 40 includes the input unit 15 and display 16. The user interface 40 may be a liquid-crystal display with a touch panel and thus may be a unitary body including the input unit 15 and display 16.

The communication interface (I/F) 17 communicates with another apparatus, such as a database, and may comply with Ethernet (registered trademark), fiber-distributed data interface (FDDI), Wi-Fi (registered trademark), and other standards.

The image forming unit 18 forms an image of a received video on a recording medium, such as paper sheet. The method of forming image may be a toner system or an ink-jet system. The image forming unit 18 may have, for example, a copy function, print function, and other functions.

Operation of the image processing apparatus 10 is described below.

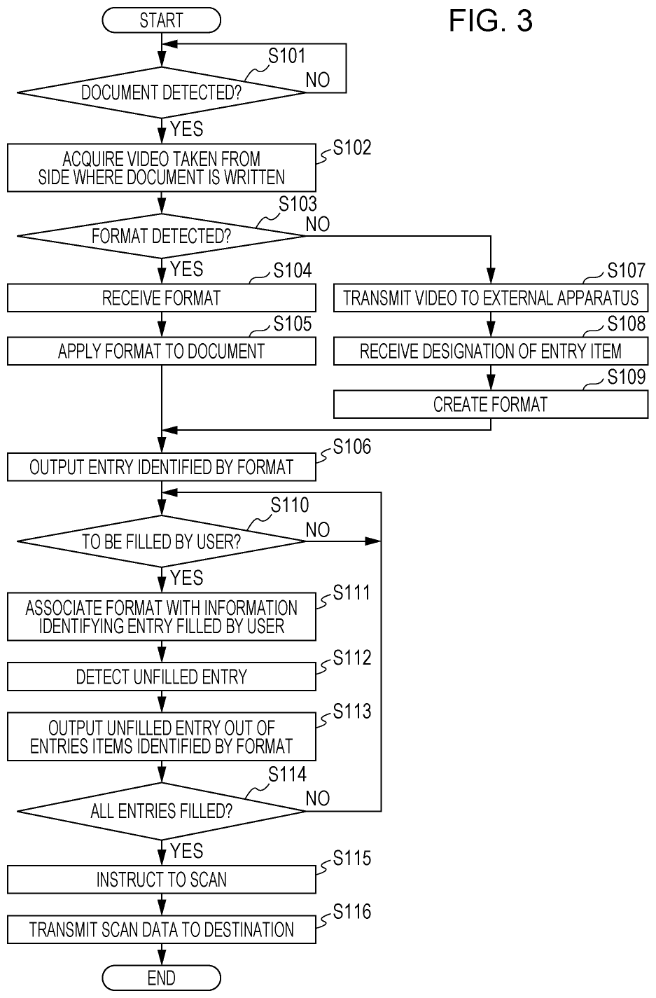

FIG. 3 is a flowchart illustrating the flow of the assistance process performed by the image processing apparatus 10. The CPU 11 executes an assistance program by reading an assistance program from the ROM 12 or the storage 14, and loading the assistance program on the RAM 13, and then executing the assistance program.

In step S101, the CPU 11 determines whether a document has been detected.

Specifically, the CPU 11 determines whether a document is placed in the document placement region 32 of the document holder 30. If a document is determined to be detected (yes in step S101), the CPU 11 proceeds to step S102. If no document is determined to be detected (no in step S101), the CPU 11 waits on standby until a document is detected.

In step S102, the CPU 11 acquires a video that is photographed from a side of a document 1 where the document 1 is filled in. The “video that is photographed from the side of the document 1 where the document 1 is filled in” refers to a video that is photographed by the document camera 70 that is placed above a writing surface of the document 1 or a video that represents entries that are photographed using a smart phone or tablet terminal. The CPU 11 proceeds to step S103.

In step S103, the CPU 11 determines whether a format has been detected. If a format is determined to be detected (yes in step S103), the CPU 11 proceeds to step S104. If no format is determined to be detected (no in step S103), the CPU 11 proceeds to step S107.

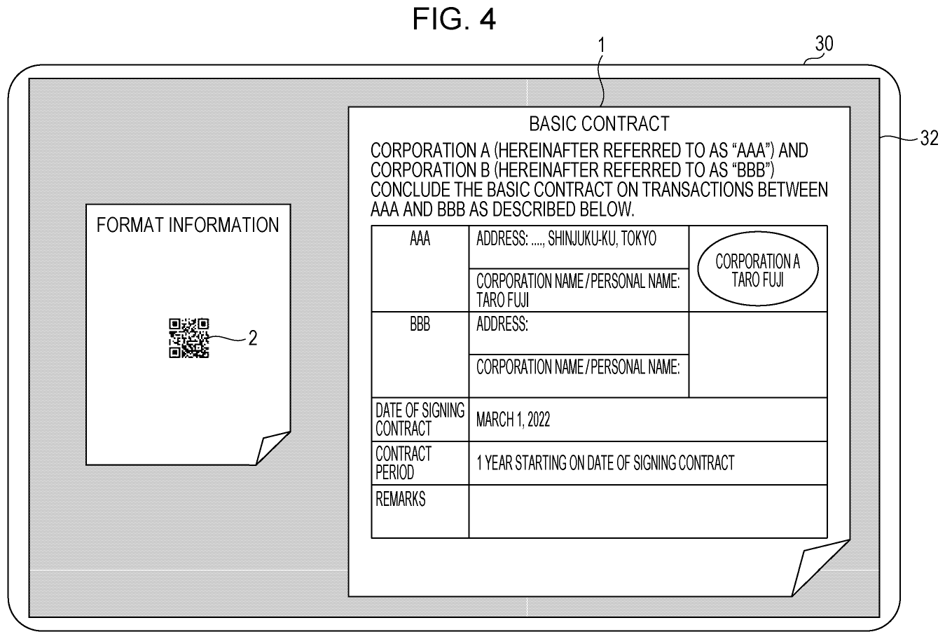

FIG. 4 illustrates an example of the document 1 and identification notification 2 placed on the document holder 30. A user may fill, in the document 1, entries including a user address, sign and seal the document 1. For example, the document 1 is a contract or one of a variety of application forms. The identification notification 2 is an identifier representing information identifying a format. For example, the identification notification 2 may be a character string, such as a uniform resource locator (URL) and an identification number, or a paper sheet or a marker, each having two-dimensional code. The identification notification 2 may be printed on the document 1. The format may be a template that is produced in advance to identify an entry. When the document 1 is placed on the document placement region 32, the image processing apparatus 10 detects the document 1. When the identification notification 2 is present in the document placement region 32, the image processing apparatus 10 detects the identification notification 2. Specifically, by detecting the identification notification 2, the image processing apparatus 10 detects the format identified by the identification notification 2.

In step S104, the CPU 11 receives the format. The CPU 11 receives a video that is captured by photographing the identification notification 2 and thus acquires the format identified by the identification notification 2. The CPU 11 may receive the designation of the format from the input unit 15. The CPU 11 proceeds to step S105.

In step S105, the CPU 11 applies the format to the document 1. If multiple documents 1 are placed on the document placement region 32, the formats may be respectively applied to the documents 1 or one format may be applied to the multiple documents 1. The CPU 11 proceeds to step S106.

In step S106, the CPU 11 outputs the entry identified by the format. The CPU 11 proceeds to step S110.

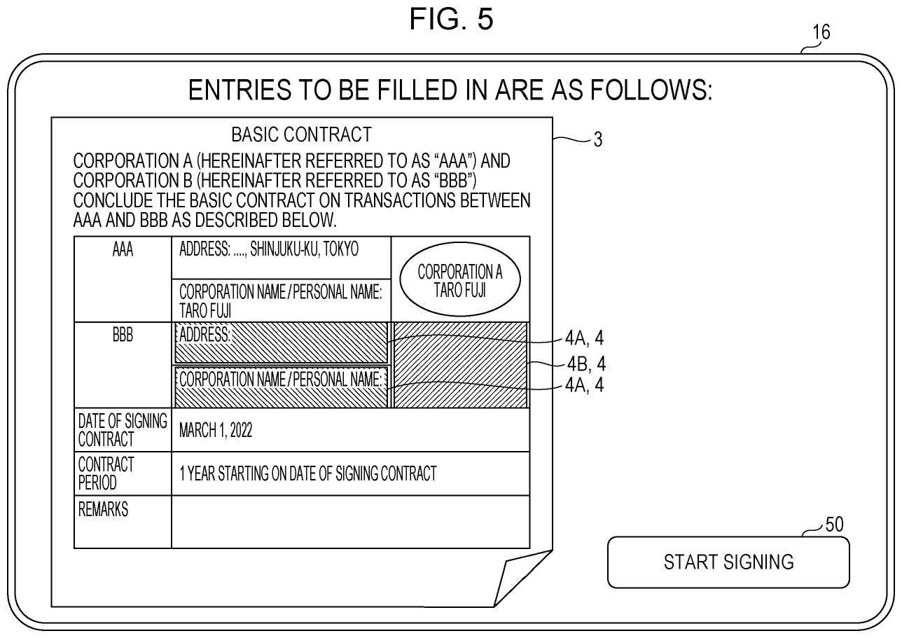

FIG. 5 illustrates an example of a document display region 3 displayed on the display 16. The document display region 3 is a region that displays the document 1 in the photographed video. FIG. 5 illustrates a screen of the document display region 3 corresponding to the document 1 in FIG. 4. In other words, the image processing apparatus 10 displays, on the document display region 3, the document 1 photographed by the document camera 70. The document display region 3 includes an entry display region 4. The entry display region 4 is a region that indicates entries. The image processing apparatus 10 displays the entry display region 4 in superimposition on the entries identified by the format. When a sign start button 50 is selected, the image processing apparatus 10 may accept filling from the user.

The image processing apparatus 10 may highlight or blink the entry display region 4 in a display form. The image processing apparatus 10 may modify the display form of the entry display region 4 depending on the type of the entry. The type of the entry may indicate whether the filling target at the entry is a character form or an image form. In the character form, the filling target at the entry is character and in the image form, the filling target is image. The type of the entry may be a description form or a selection form. The type of the entry may be an entry of address or phone number or an entry of a character-only form or a number-only form. The type of the entry may be an image form, such as seal, identification (ID) photo, postage stamp, and a variety of other stamps. Referring to FIG. 5, the image processing apparatus 10 displays a field for an address and company name/personal name as an entry display region 4A in the character form and a field for a seal in a drawing form as an entry display region 4B.

In step S107, the CPU 11 transmits the video to an external apparatus. For example, the CPU 11 transmits the video to a terminal apparatus operated by an operator who is familiar with the document 1. The CPU 11 proceeds to step S108.

In step S108, the CPU 11 receives a designation of the entry. For example, the CPU 11 receives the designation specified by a user or an operator who operates the external apparatus. The CPU 11 proceeds to step S109.

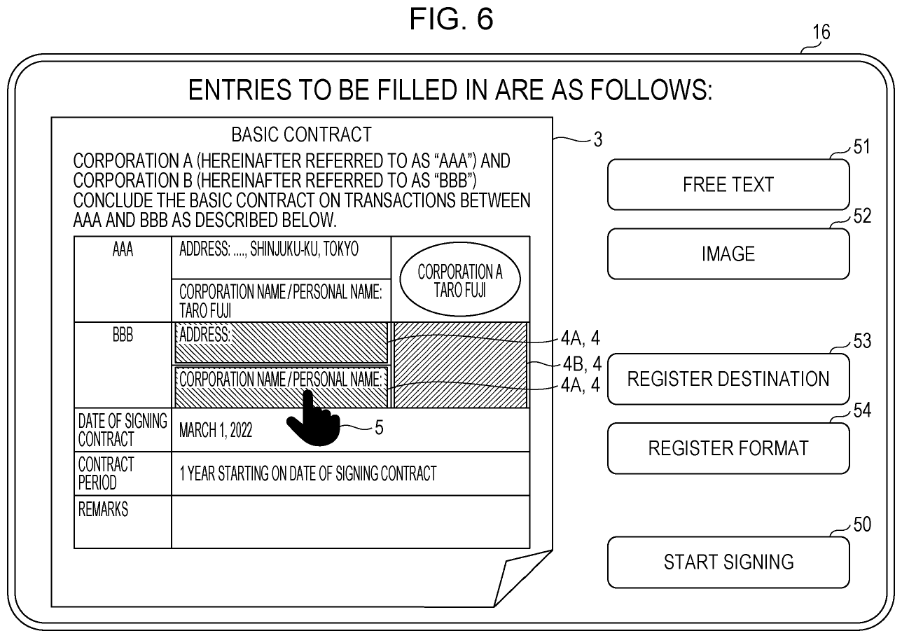

FIG. 6 illustrates an example of the display 16 that receives the designation of the entry. The image processing apparatus 10 displays on the display 16 a pointer 5, free-text button 51, image button 52, destination registration button 53, and format registration button 54. The pointer 5 is coordinates on the display 16 that the user specifies using the input unit 15.

If the free-text button 51 is selected, the image processing apparatus 10 sets the type of the entry falling within a range specified by the pointer 5 to free text in the image form.

If the image button 52 is selected, the image processing apparatus 10 sets the type of the entry falling within the range specified by the pointer 5 to the image form.

If the destination registration button 53 is selected, the image processing apparatus 10 displays on the display 16 a screen used to register a destination. The image processing apparatus 10 may associate the destination with the format.

If the format registration button 54 is selected, the image processing apparatus 10 registers the format. Specifically, the image processing apparatus 10 sets the set type of the entry or the associated destination in the format.

In step S109, the CPU 11 creates a format. Specifically, the CPU 11 creates the format by selecting the format registration button 54 described with reference to FIG. 6. The CPU 11 associates the format with information identifying the specified entry. The CPU 11 proceeds to step S106.

In step S110, the CPU 11 determines whether an entry filled by the user is present. If the entry filled by the user is determined to be present (yes in step S110), the CPU 11 proceeds to step S111. If the entry filled by the user is not determined to be present (no in step S110), the CPU 11 waits on standby until entry filling by the user occurs.

In step S111, the CPU 11 associates the format with the information identifying the entry filled by the user. Specifically, the CPU 11 updates the format such that the entry filled by the user is recognized as a filled entry. The CPU 11 proceeds to step S112.

In step S112, the CPU 11 detects an unfilled entry. Specifically, the CPU 11 detects an unfilled entry of the document in the video. For example, the CPU 11 compares the video at the time of step S102 with the video at the present time and detects an unfilled entry that remains unchanged between the videos. For example, the CPU 11 detects as an unfilled entry an entry, from which text is not detected through optical character recognition (OCR). The CPU 11 proceeds to step S113.

In step S113, the CPU 11 outputs an unfilled entry out of the entries identified by the format. For example, the CPU 11 displays a region of the unfilled entry in superimposition on the video. For example, the CPU 11 may output the unfilled entry by displaying or reading aloud an entry name of the unfilled entry. The CPU 11 proceeds to step S114.

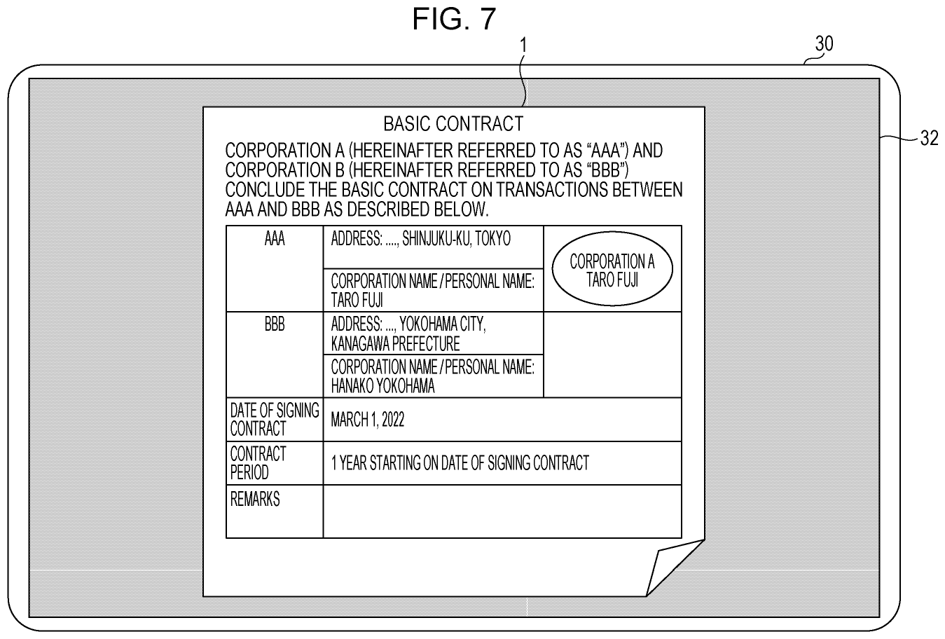

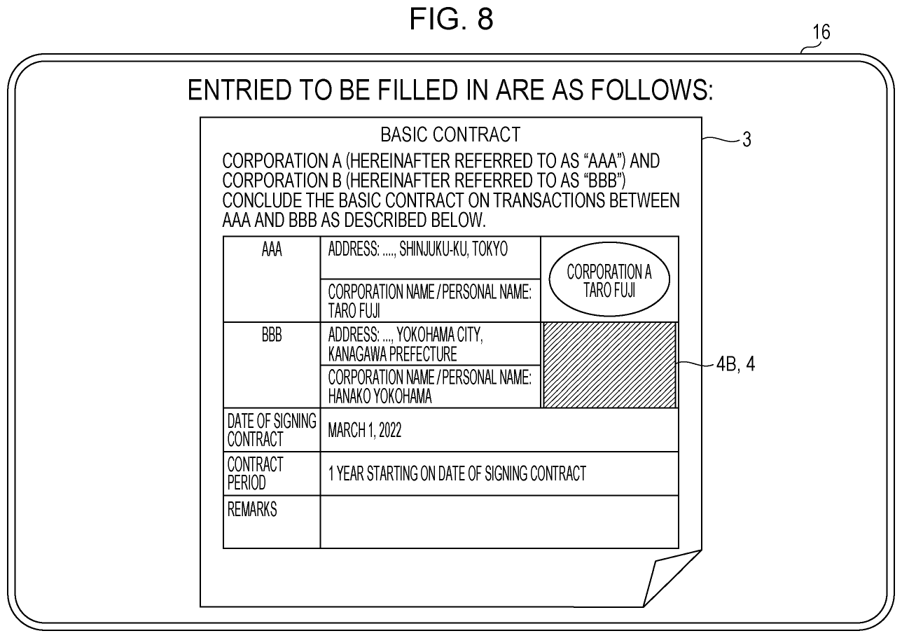

FIGS. 7 and 8 illustrate an example of a process that is performed when an entry is filled by the user. FIG. 7 illustrates an example of the document 1 placed on the document holder 30. The document 1 in FIG. 7, different from the document 1 in FIG. 4, has an address written and is signed, but not sealed.

FIG. 8 illustrates the document display region 3 corresponding to the document 1 in FIG. 7 and is an example of the document display region 3 displayed on the display 16. The document display region 3 in FIG. 8 is with the entry display region 4A deleted from the screen on the display 16 in FIG. 5, but still has the entry display region 4B displayed. If there is no longer an unfilled entry with the unfilled entry filled, the image processing apparatus 10 modifies the display form, for example, by deleting the entry display region 4.

In step S114, the CPU 11 determines whether all the entries are filled. If all the entries are determined to be filled (yes in step S114), the CPU 11 proceeds to step S115. If there remains an unfilled entry (no in step S114), the CPU 11 returns to step S110.

In step S115, the CPU 11 provides an instruction to execute scanning. Specifically, the CPU 11 executes scanning using the image forming unit 18. The CPU 11 proceeds to step S116.

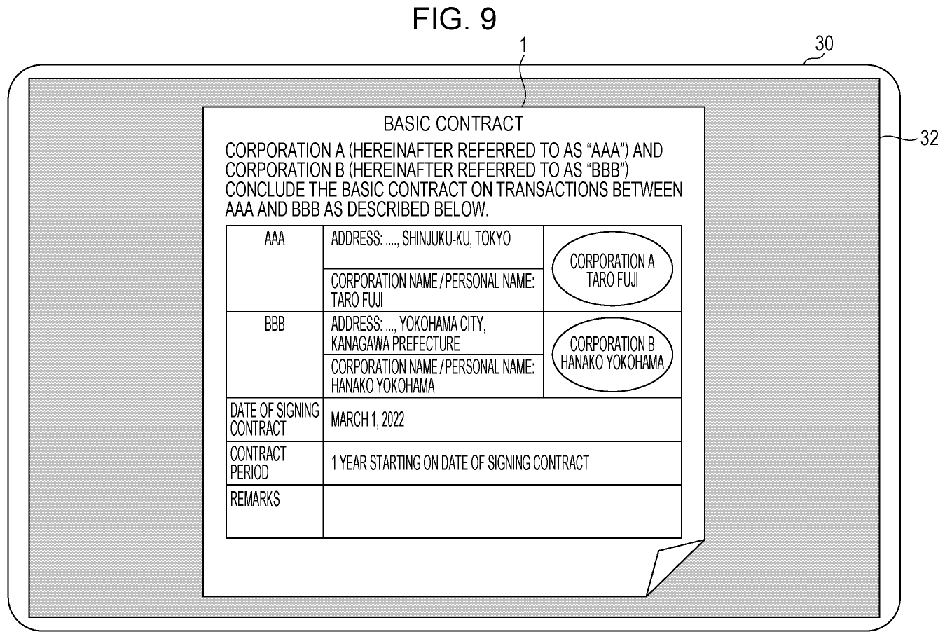

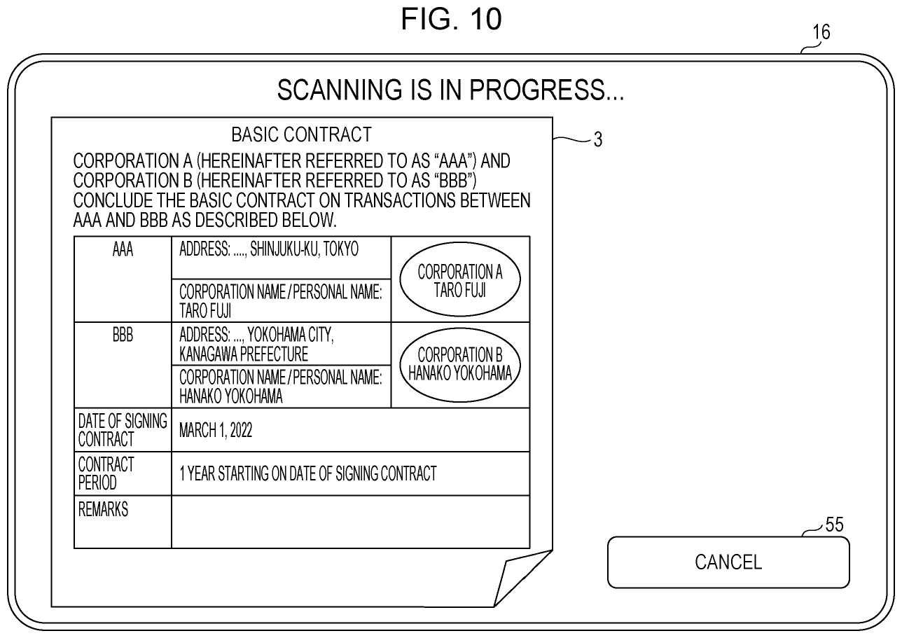

FIGS. 9 and 10 illustrate process examples in which the user fills all the entries. FIG. 9 illustrates the document 1 placed on the document holder 30. The document 1 in FIG. 9, different from the document 1 in FIG. 7, is sealed with all the entries filled.

FIG. 10 illustrates a screen of the document display region 3 corresponding to the document 1 in FIG. 9. FIG. 10 illustrates an example of the document display region 3 displayed on the display 16. Referring to the document display region 3 in FIG. 10, the entry display region 4B on the screen of the display 16 in FIG. 8 is removed, and none of the entry display regions 4 are displayed. If all the entries are filled in the document 1, the image processing apparatus 10 provides an instruction to execute scanning. If a cancel button 55 is selected, the image processing apparatus 10 quits executing scanning.

In step S116, the CPU 11 transmits scan data to a destination. For example, the CPU 11 transmits the scan data to the destination associated with the format. The CPU 11 thus ends the process.

As described above, in the process from step S101 to step S113, the CPU 11 captures the video photographed from the side of the document having the entries and outputs the unfilled entry in the video.

### Modifications

The image processing apparatus 10 of the exemplary embodiment has been described. The disclosure is not limited to the exemplary embodiment. A variety of changes and modification are possible to the disclosure.

According to the exemplary embodiment, the information processing apparatus is the image processing apparatus 10. The information processing apparatus is not limited to the image processing apparatus 10. The information processing apparatus may be integrated with or separate from the image processing apparatus. For example, the information processing apparatus may be a smart phone or a tablet terminal with a camera and may output an unfilled entry in accordance with a video photographed by the camera.

When the format is detected, the image processing apparatus 10 of the exemplary embodiment may receive the designation of the entry from the user. Specifically, when the format is detected, the CPU 11 may perform, in the operation in step S103 in FIG. 3, operations in steps S107 through S109 in addition to operations steps S104 and S105. In this case, the CPU 11 updates the detected format in step S109.

The image processing apparatus 10 of the exemplary embodiment may detect an unfilled entry in accordance with related-art techniques. For example, the image processing apparatus 10 may extract from the document 1 in the video a rectangle and an entry name and may determine whether the rectangle is an entry.

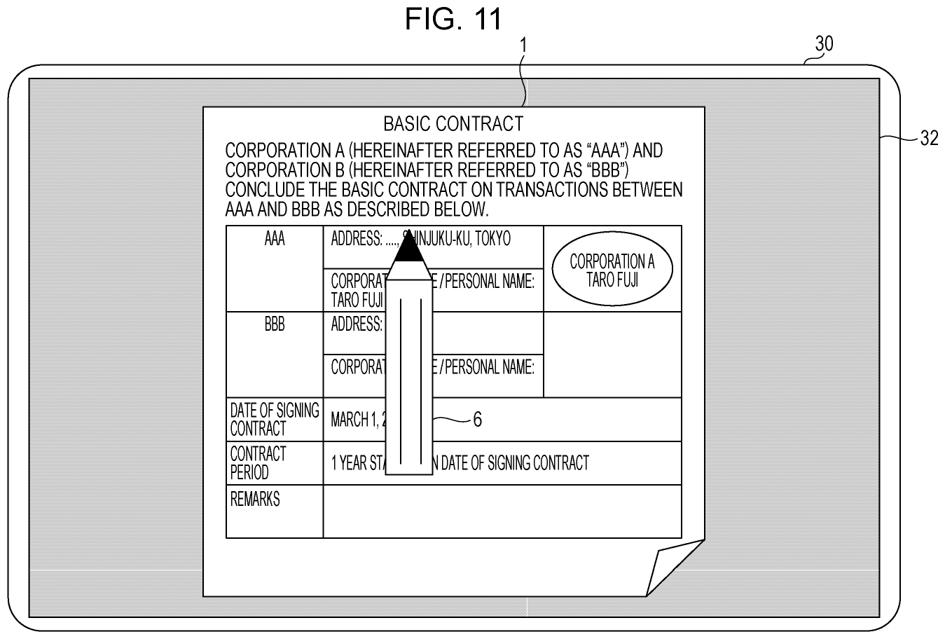

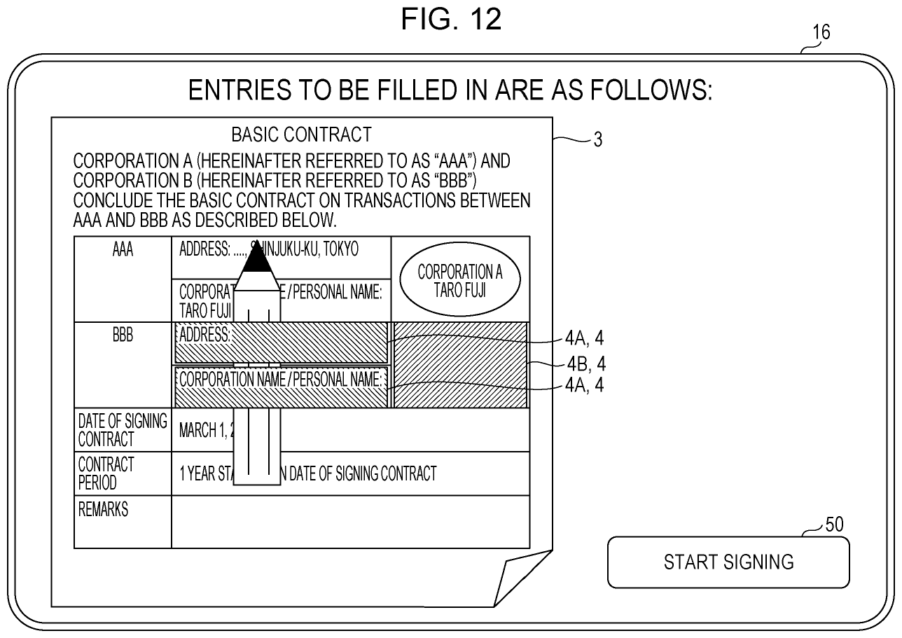

If a shield 6 is photographed overlapping on the region of the unfilled entry, the image processing apparatus 10 of the exemplary embodiment may display the region of the unfilled entry in superimposition on the shield 6. FIGS. 11 and 12 illustrate a process example in which the shield overlaps the region of the unfilled entry. FIG. 11 illustrates a document placed on the document holder. Referring to FIG. 11, part of the unfilled entry is not displayed because of a pencil serving as the shield 6 in the video photographed by the document camera 70.

FIG. 12 illustrates a screen of the document display region 3 corresponding to the document 1 in FIG. 11 and is an example of the document display region 3 displayed on the display 16. The image processing apparatus 10 displays the entry display region 4A in superimposition on the pencil serving as the shield 6.

The image processing apparatus 10 of the exemplary embodiment may output supplementary information related to an entry. In step S113 in FIG. 3, the CPU 11 displays, on the display 16, help information related to an unfilled entry, such as an entry, contents of the entry, or a filling method.

The process described above may be implemented using a dedicated hardware circuit. In such a case, the hardware circuit may be implemented using a single piece of hardware or multiple pieces of hardware.

In the embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The program causing the image processing apparatus 10 to operate may be delivered by a computer readable recording medium, such as a universal serial bus (USB) memory, flexible disk, or compact disc read-only memory (CD-ROM). The program may be delivered online via a network, such as the Internet. In such a case, the program recorded on a computer readable recording medium is typically transferred to a memory, storage, or the like to be recorded. The program may be delivered as a single piece of application software or may be built into software of each apparatus serving as a function of the image processing apparatus 10.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

An information processing apparatus including:
a processor configured to:
   acquire a video captured by photographing a side of a document where an entry is filled; and
   output an unfilled entry of the document in the video.
      (((2)))

The information processing apparatus according to (((1))), wherein the processor is configured to:
receive a format identifying the entry of the document; and
output the entry identified by the format of the document in the video.
   (((3)))

The information processing apparatus according to (((2))), wherein the processor is configured to:
receive a video captured by photographing an identification notification representing information identifying the format; and
apply to the document a format identified by the photographed identification notification.
   (((4)))

The information processing apparatus according to any of one of (((2))) and (((3))), wherein the processor is configured to:
receive a designation of the entry designated by a user; and
associate the format with information identifying the designated entry.
   (((5)))

The information processing apparatus according to any one of (((2))) through (((4))), wherein the processor is configured to associate, in accordance with the video, the format with information identifying the entry filled by a user.

(((6)))

The information processing apparatus according to apparatus according to any one of (((1))) through (((5))), wherein the processor is configured to display a region of the unfilled entry in superimposition on the video.

(((7)))

The information processing apparatus according to (((6))), wherein the processor is configured to modify a display form of the region of the unfilled entry in accordance with a type of the unfilled entry.

(((8)))

The information processing apparatus according to one of (((6))) and (((7))), wherein the processor is configured to, if a shield is photographed overlapping the region of the unfilled entry, display the region of the unfilled entry in superimposition on the shield.

(((9)))

The information processing apparatus according to one of (((1))) through (((8))), wherein the processor is configured to, if all entries are filled, provide an instruction to perform scanning.

(((10)))

A program causing a computer to execute a process processing information, the program including:
acquiring a video captured by photographing a side of a document where an entry is filled; and
outputting an unfilled entry of the document in the video.

What is claimed is:

1. An information processing apparatus comprising:
a processor configured to:
acquire a video captured by photographing a side of a document where an entry is filled; and
output an unfilled entry of the document in the video.

2. The information processing apparatus according to claim 1, wherein the processor is configured to:
receive a format identifying the entry of the document; and
output the entry identified by the format of the document in the video.

3. The information processing apparatus according to claim 2, wherein the processor is configured to:
receive a video captured by photographing an identification notification representing information identifying the format; and
apply to the document a format identified by the photographed identification notification.

4. The information processing apparatus according to claim 2, wherein the processor is configured to:
receive a designation of the entry designated by a user; and
associate the format with information identifying the designated entry.

5. The information processing apparatus according to claim 2, wherein the processor is configured to associate, in accordance with the video, the format with information identifying the entry filled by a user.

6. The information processing apparatus according to claim 1, wherein the processor is configured to display a region of the unfilled entry in superimposition on the video.

7. The information processing apparatus according to claim 6, wherein the processor is configured to modify a display form of the region of the unfilled entry in accordance with a type of the unfilled entry.

8. The information processing apparatus according to claim 6, wherein the processor is configured to, if a shield is photographed overlapping the region of the unfilled entry, display the region of the unfilled entry in superimposition on the shield.

9. The information processing apparatus according to claim 1, wherein the processor is configured to, if all entries are filled, provide an instruction to perform scanning.

10. A non-transitory computer readable medium storing a program causing a computer to execute a process processing information, the process comprising:
acquiring a video captured by photographing a side of a document where an entry is filled; and
outputting an unfilled entry of the document in the video.

11. An information processing method comprising:
acquiring a video captured by photographing a side of a document where an entry is filled; and
outputting an unfilled entry of the document in the video.
